(19) United States
(12) Patent Application Publication
(10) Pub. No.: US 2015/0311833 A1
(43) Pub. Date: Oct. 29, 2015

(54) GENERAL-PURPOSE DESIGN OF DC-AC INVERTERS IN ELECTRIFIED AUTOMOBILE SYSTEMS

(71) Applicant: Advanced Power Electronic Solutions, LLC., Flint, MI (US)

(72) Inventors: Hua BAI, Flint, MI (US); Zhong NIE, Flint, MI (US); Allan TAYLOR, Grand Blanc, MI (US)

(73) Assignee: Advanced Power Electronic Solutions, LLC., Flint, MI (US)

(21) Appl. No.: 14/264,906

(22) Filed: Apr. 29, 2014

(51) Int. Cl. H02P 5/74

(52) U.S. Cl. CPC H02P 5/74

(57) ABSTRACT

A general purpose DC-AC inverter in an electrified automobile system provides DC-AC inverter control based on different types of the motors. The DC-AC converter is configured to convert a voltage from a primary battery system of the EV to different voltage/current waveforms. One controller controls different types of motors without changing the firmware. Sensorless control is also achieved based on the same firmware.

### FIELD

This discussion relates generally to electrified automobiles and, more particularly, to at least an apparatus and a method for the design of DC-AC inverters for motor drive systems in electric vehicles.

### BACKGROUND

An electrified vehicle (EV) is usually understood to be a vehicle that can be propelled using electric power, i.e., an electric current. Examples of EVs include plug-in hybrid EVs (PHEVs), fuel cell electric vehicles (FCEVs), and battery electric vehicles (BEVs). The EV may include a primary battery system of one or more batteries outputting a direct current (DC) voltage that can be used to rotatably drive an electric motor to generate drive torque for propelling the EV. For example, the DC voltage may be converted to three-phase alternating current (AC) voltages by a three-phase inverter, and the three-phase AC voltages can be used to rotatably drive a three-phase electric motor. The EV may also include a secondary battery system, e.g., a 12V lead-acid battery, which can be used to power low-voltage components of the EV.

An electrified vehicle (EV) can include a battery system that outputs a direct current (DC) voltage. This battery system can be referred to as a primary battery system because it can be used to power an electric motor to propel the EV. For example, but not by way of limitation, a primary battery system in an electrified golf cart or an electrified bike can be a battery pack, including a plurality of lithium-ion (Li-ion) batteries having a collective voltage of 30-60 V. The EV can also include a secondary battery system with one or more batteries. A DC/AC inverter between the primary battery system and a three-phase motor can be used to convert the DC current output from the battery to a three-phase AC current to supply power to the three-phase motor.

The on-board three-phase motor converts electrical energy of the motor to mechanical energy propelling the wheel. There are, however, different types of motors. The most economical motor is an induction motor, which has no permanent magnet on the rotor surface. However, an induction motor is also difficult to control since the controller of the motor needs to create magnetic fields to drag the motor. Also, the reactive power inside the induction motor is bigger than that of other types of motors, which accounts for its lower efficiency and bulky size.

A second type of motor, i.e., a permanent magnet synchronous motor, has a rotor side with magnets, and no need of a stator side to create flux. This increases the motor's efficiency and power factor, but also its price, which intimidates some light-power-EV producers, for example, electrified-bike and electrified-scooter producers. In addition, the risk of demagnetization could potentially endanger vehicle safety. Further, the control algorithm of a permanent magnet synchronous motor is complex.

A third type of motor, i.e., a brushless DC motor is widely used in EV drive systems. The structure of a brushless DC motor is similar to that of a permanent magnet synchronous motor. However, the brushless DC motor adopts trapezoidal back electromotive force (EMF) instead of the sinusoidal waveform, which increases its power density. Nevertheless, the brushless DC motor has a bigger torque ripple, which may lower the driving comfort of the motor.

The above described three types of the motors usually employ different speed/position sensors. A brushless DC motor uses a 5-wire Hall effect sensor; a permanent magnet synchronous motor uses a 6-wire resolver; and an induction motor uses a 4-wire quadrature encoder. In order to control different motors, inverter suppliers have to redesign the motor system to accommodate the sensor change, which prolongs the product development period and increases cost.

### SUMMARY

Some example embodiments of the inventive concept address the above mentioned drawbacks of conventional art by providing a design of a DC/AC inverter which accommodates all three types of motors. When the motor type is switched, only a software change is necessary. In some example embodiments, such a change does not require any firmware revision.

In an example embodiment, an electrified vehicle (EV) includes motors of different types, a primary battery system, a controller, and a drivetrain. The controller includes a processor and a DC-AC inverter having different interfaces corresponding to the different motor types. The DC-AC inverter is configured to convert the voltage from the primary battery system to a voltage and current suitable to a specific type of motor of the EV.

In an example embodiment, the DC/AC inverter is divided into three functional blocks, i.e., a control board, a gate-drive board, and a power board

In an example embodiment, the motors are implemented with a plurality of speed/position sensors to determine at least one of the motor speed information and the motor position information of the motors.

In an example embodiment, one wire slot is implemented at the interface of the control board and the plurality of sensors to accommodate all the speed/position sensors.

In an example embodiment, the control board has pins for all the speed/position sensors and each of the sensors is independently wire-connected to the microcontroller unit (MCU) of the control board.

In an example embodiment, there is a mixing zone in the wire slot to accommodate all the sensors, and the control board is configured with jumpers to select a sensor from the plurality of speed/position sensors.

In an example embodiment, the EV is configured to use on-board voltage and current sensors to estimate at least one of the speed and position information of the plurality of motors without using the speed/position sensors.

In an example embodiment, the plurality of motors are a brushless DC motor, an induction motor and a permanent magnet synchronous motor. In an example embodiment, the EV is implemented with a five-wire Hall-effect sensor to control the brushless DC motor in terms of high power density, a four-wire encoder to control the induction motor in terms of the cost reduction, and a six-wire resolver to control the permanent magnet synchronous motor in terms of the low torque ripple and high power factor.

In an example embodiment, a method for controlling the plurality of motors in an EV is provided. The method includes determining, by the plurality of speed/sensors, the speed/position information of the plurality of motors; generating, by the control board, a control signal based on the determined speed/position information; converting, by the gate-drive board, the control signal into a gate signal; and controlling, by the power board, the voltage/current supplied to the a plurality of motors based on torque requests of the motors.

In an example embodiment, the controlling includes controlling the brushless DC motor, the induction motor and the permanent magnet synchronous motor.

In an example embodiment, the control signal generated by the control board is six pulse-width modulation (PWM) signals.

In an example embodiment, the method further provides speed/position sensorless control using the on-board voltage and current sensors in order to reduce the assembly cost and enhance the robustness.

In an example embodiment, the method may include a general-purpose design for a DC-AC inverter based on a motor type provided in the EV, the DC-AC inverter being configured to convert a voltage from a primary battery system of the EV to the secondary voltage for the three-phase motor in the EV.

The subject matter below is taught by way of various specific example embodiments explained in detail, and illustrated in the enclosed drawing figures.

### BRIEF DESCRIPTION OF THE DRAWINGS

FIG. 1 illustrates a functional block diagram of an electrified vehicle (EV) according to an example embodiment.

FIG. 2 illustrates a circuit diagram of a DC-AC inverter in a motor drive system of an EV.

FIG. 3 represents a schematic block diagram illustrating a firmware design of a

DC-AC inverter of an EV according to an example embodiment.

FIGS. 4(a)-4(c) represent a functional block diagram of a control board in which FIG. 4(a) illustrates the control board connection to different types of the motors, in which FIG. 4(b) illustrates a strategy #1 in which each sensor has a connection pin in the control board and is independently wire-connected to the microcontroller unit (MCU) of the control board, and in which FIG. 4(c) illustrates a strategy #2 in which a mixing zone in the wire slot is created to accommodate different types of motors, and jumpers are used for a selection of a specific type of motor.

FIG. 5 represents a flow diagram illustrating DC-AC inverter control for a brushless DC motor.

FIG. 6 represents a flow diagram illustrating DC-AC inverter control for a permanent magnet synchronous motor.

FIG. 7 represents a flow diagram illustrating DC-AC inverter control for an induction motor.

FIG. 8 represents a flow diagram illustrating DC-AC inverter control using a sensorless technique.

### DETAILED DESCRIPTION

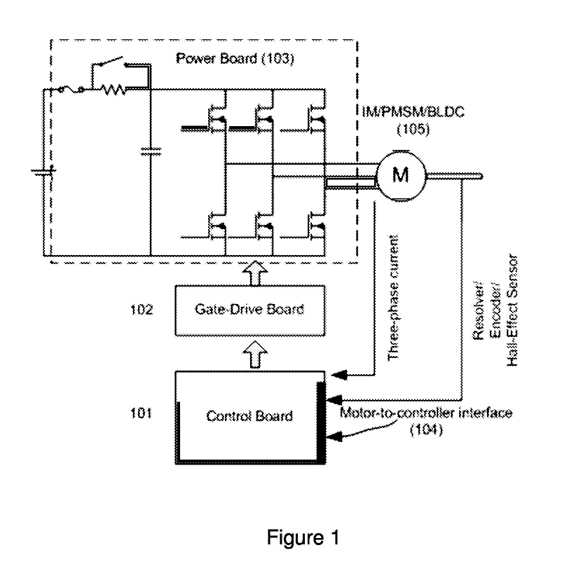

FIG. 1 illustrates a functional block diagram of an electrified vehicle (EV) according to an example embodiment. As shown in the figure, the DC/AC inverter system of the EV is divided into three blocks, i.e., control board 101, gate-drive board 102 and power board 103.

In an example embodiment, as shown in the figure, the system accepts three different types of motors (105), i.e., an induction motor (IM), a permanent magnet synchronous motor (PMSM), and a brushless DC motor (BLDC). Although the selection of the motors (105) primarily described in this specification is the above mentioned three example types of motors, the selection of the motors (105) are not limited to the three exemplary motors. It is within the inventive concept to use any other types of AC or DC motors, for example, a brushed DC motor or a switched reluctance motor, etc. It is also within the inventive concept to use as motors a combination of any numbers of different types of motors (105).

Corresponding to the three different types of motors, in an example embodiment, the system adopts three different types of speed/position sensors. That is, the system uses a Hall-effect sensor for the brushless DC motor, a resolver for the permanent magnet synchronous motor, and an encoder for the induction motor. However, the selection of the speed/position sensors is not limited to the above mentioned sensors. It is also within the inventive concept to use any other sensors suitable for the different types of motors. It will be understood therefore that in this description, the more general term “sensor” includes speed/position sensors as well as other types of sensors not described in detail here. Moreover, it will also be understood that the more general term “sensor information” includes speed/position information, speed information, and/or position information.

In an example embodiment, instead of using the above mentioned three particular sensors, the system may use on-board three-phase voltage sensors and/or a three-phase current sensors to estimate the speed/position information of the motors in order to reduce the assembly cost and enhance the robustness of the system.

As shown in FIG. 1, the signals acquired by the Hall-effect sensor, resolver, and encoder, as well as the signal acquired by the on-board three-phase voltage sensors and/or three-phase current sensors, are transmitted to the control board 101 through the motor-to-controller interface (104).

Based on the acquired sensor signals, the control board 101 generates a control signal and transmits the generated control signal to the gate-drive board 102. In an example embodiment, the control signals are pulse-width modulation (PWM) signals. The control board 101 is implemented with control algorithms which independently control the Hall effect sensor, the resolver, and the encoder, as well as the on-board voltage/current sensors. Therefore, when a motor type switches from one to another, there is no need to change the firmware. This shortens the development cycle and lowers the system cost.

In an example embodiment, the control board 101 is implemented with other circuits and sensors, such as a controller area network (CAN) communication circuit, protection circuit, temperature sensor, DC voltage/current sensor, signal conditioning circuit, external watchdog circuit, etc. The control board 101 can be further implemented with analog inputs, with digital inputs/outputs for data input/output, and power supply.

According to the received control signal, the gate-drive board 102 generates a gate signal to drive the power board 103. The power board 103 controls output power to the motors, and therefore controls voltage/current and speed/position of the motors. The voltage/current and speed/position signals detected by the Hall-effect sensor, resolver, encoder, and on-board three-phase voltage sensors and/or a three-phase current sensors are transmitted to the control board 101 as feedback signals.

In an example embodiment, in addition to the three-phase current or the three-phase voltage, the control board is also implemented to sample other types of current and/or voltage, for example, a dc-bus current/voltage.

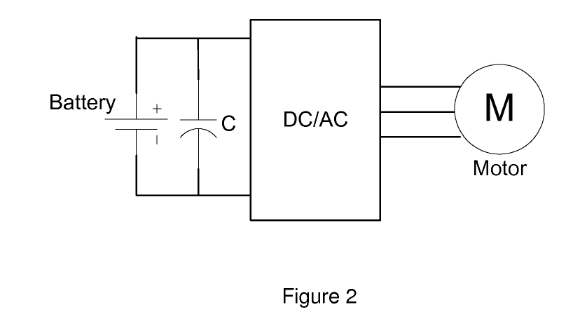

FIG. 2 is a circuit diagram of a DC-AC inverter in a motor drive system of an EV. The primary battery of the system provides a DC current. A capacitor between the battery system and the inverter filters the DC current waveform. The DC-AC inverter between the primary battery system and a three-phase motor converts the DC current to a three-phase AC current so as to supply power to the three-phase motor to control the speed and/or position of the motors.

The selection of the inverter is not limited to the above mentioned voltage-source inverters. It is also within the inventive concept to use any other types of inverters, for example, current-source inverters.

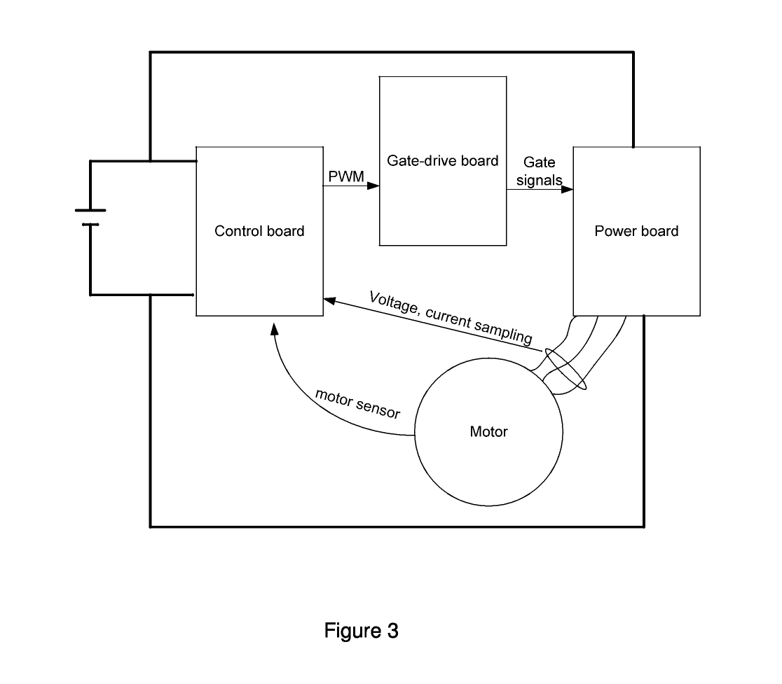

FIG. 3 is a schematic block diagram illustrating a firmware design of a DC-AC inverter of an EV according to an example embodiment. As shown in the figure, the inverter system according to this example embodiment is divided into three functional blocks, that is, a control board, a gate-drive board and a power board. Based on the speed/position information detected by the motor sensors, the control board generates a control signal.

In an example embodiment, the generated control signals are PWM signals. The gate-drive board converts the PWM signals into gate signals and outputs the gate signals to the power board to control the electrified powertrain based on the torque request, such that the electrified powertrain outputs a desired drive torque to the motor. The drivetrain can include any suitable components for propelling the EV (a transmission, a torque converter, four wheels, etc.). It will be understood that the components of the drivetrain can be grouped in various different manners. The driver interface can include any suitable components for interacting with a driver of the EV (an accelerator pedal, gauges/displays, etc.). In an example embodiment, the voltage/current supplied to the motor are sampled and sent to the control board to form a feedback control.

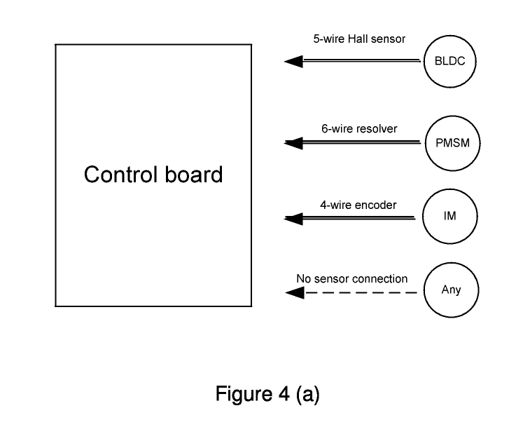

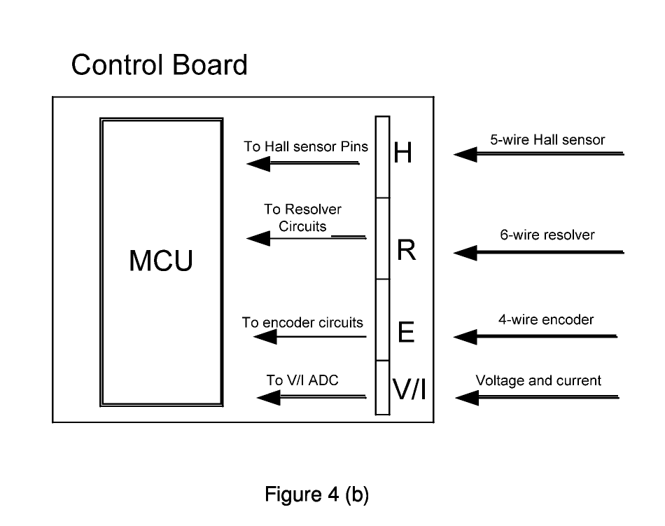

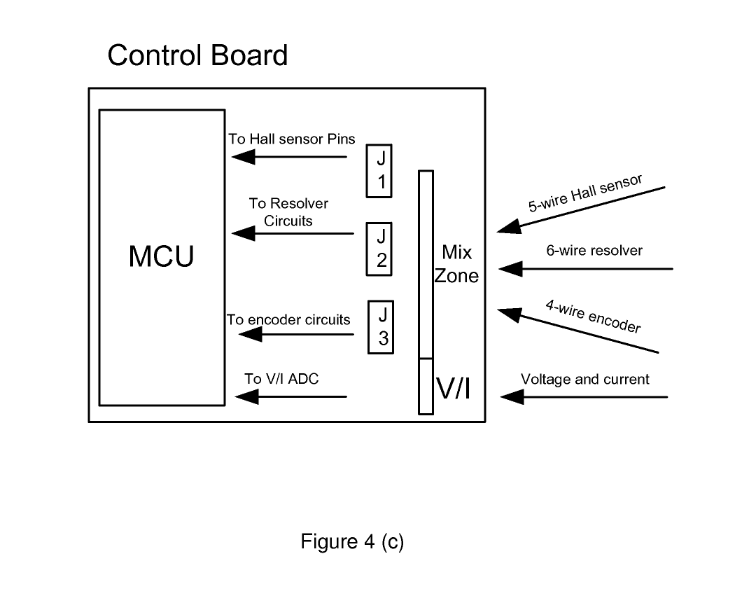

FIG. 4 represents a functional block diagram of a control board according to an example embodiment. FIG. 4(a) illustrates the connection of the control board to different types of motors. In an example embodiment, one wire slot is utilized to accommodate all three different sensors, i.e., Hall-effect, resolver and encoder. In accordance with this approach, two alternative example embodiments are employed as shown in FIG. 4(b) and FIG. 4(c.

In one embodiment, as shown in FIG. 4(b), strategy #1 is used in connecting the control board to the different types of motors. Strategy #1 is implemented using the pins for all the possible sensors. The wire slot, in this example embodiment, includes connectors for multiple sensors. For example, the 5-wire Hall-effect sensor is connected through connector H which is in turn connected to the Hall-effect sensor pins, the 6-wire resolver is connected through connector R which is in turn connected to the resolver circuits, the 4-wire encoder is connected to connected E which is in turn connected to the encoder circuits, and the on-board voltage/current connects through connector V/I which is in turn connected to the V/I ADC. All the wires of the connectors are independently connected to the microcontroller unit (MCU) of the control board, which contains corresponding circuits and control algorithms for the different sensors. When users need to control a specific type of motor, they need only to connect the sensor wires to the appropriate predefined pins of the connectors forming the wire slot. Typical MCUs that include all three types of sensors are a TMS320F28335, a Texas Instrument floating point digital signal processor (DSP), and a Freescale MCU (Cobra, Mamba and Andorra). These concrete examples are mentioned simply for the sake of explanation, not by way of limitation.

In another embodiment, as shown in FIG. 4(c), strategy #2 is used in connecting the control board to different types of motors. Strategy #2 creates a mixing zone in the wire slot to accommodate three types of sensors. Jumpers (J₁, J₂ and J₃) are used to select a specific type of sensor, in a manner understood to those familiar with this field. When a brushless DC motor is used with a 5-wire Hall-effect sensor, for example, jumper J₁ is used to bridge the sensor with the MCU Hall-effect sensor zone, while J₂ and J₃ remain disconnected. When a permanent magnet synchronous motor is used with a 6-wire resolver sensor, for example, jumper J₂ is used to bridge the sensor with the MCU resolver circuit while J₁ and J₃ remain disconnected. When an induction motor is used with a 4-wire encoder, jumper J₃ is used to bridge the sensor with the MCU encoder circuit zone, while J₁ and J₂ remain disconnected. The on-board voltage/current, as in the example embodiment of FIG. 4(b), connects through connector V/I which is in turn connected to the V/I ADC.

Since strategy #1 and strategy #2 both realize speed and torque control, which needs the information of the DC-bus voltage and three-phase current of the motors, they both incorporate the V/I connector. Therefore both design strategies use the on-board voltage and current sensors.

In an example embodiment, the electrified powertrain can also include other suitable components, such as a DC/DC converter (not shown) for converting the primary DC voltage to a 12V battery to power auxiliary circuits. In an example embodiment, the EV can further include an internal combustion engine. The internal combustion engine may be configured to generate drive torque for the drivetrain, e.g., based on the torque request, and thus may be part of the electrified powertrain.

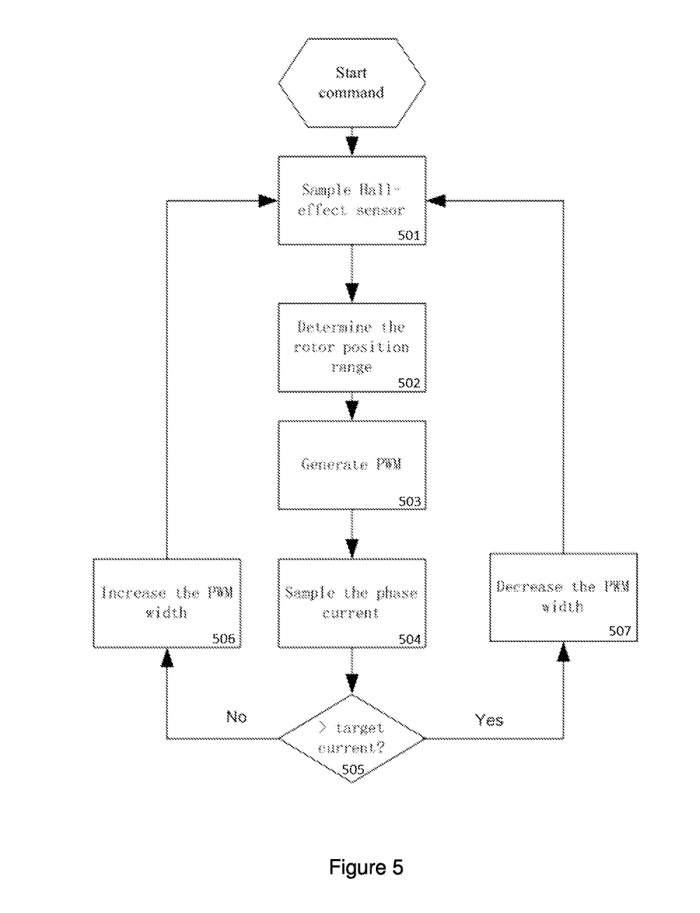

FIG. 5 represents a flow diagram illustrating an example algorithm for DC-AC inverter control for a brushless DC motor. Once a brushless DC motor is applied with a Hall-effect sensor, a control algorithm to generate the trapezoidal back EMF is demanded, as shown in FIG. 5.

In particular, at step 501, the Hall-effect sensor samples data from the brushless DC motor and transmits the acquired data to the control board. At step 502, the control board determines the motor speed and rough position range based on the data received from the Hall-effect sensor. At step 502, the Hall-effect sensor determines speed and position information of the motor and transmits the information to the control board.

At step 503, based on the speed/position data, the control board generates a control signal as a form of PWM signal, and transmits the signal to the gate-drive board. In response to receiving the control signal from the control board, the gate-drive board generates a gate signal to drive the power board. The power board controls the power supplied to the brushless DC motor.

At step 504, the control board samples the phase current supplied to the motor. Such phase current determines the torque of the brushless DC motor. At step 505, the control board compares the sampled current to a predetermined target current.

If the sampled current is greater than the predetermined target current, at step 507, the control board generates a PWM signal with a decreased duty cycle. On the other hand, if the sampled current is smaller than the predetermined target current, at step 506, the control board generates a PWM signal with an increased duty cycle. Therefore, the current is adjusted in each switching period to control the phase current.

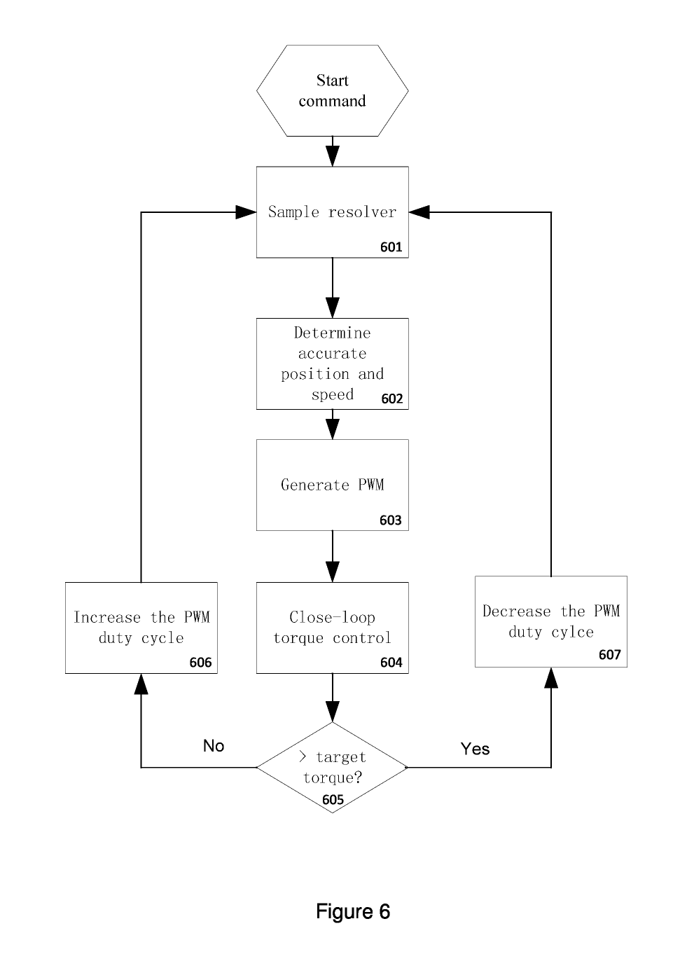

FIG. 6 represents a flow diagram illustrating a DC-AC inverter control algorithm for a permanent magnet synchronous motor. Once a permanent magnet synchronous motor is applied with a resolver circuit, a control algorithm to generate the sinusoidal back EMF is demanded, as shown FIG. 6.

In particular, at step 601, the resolver samples data from the permanent magnet synchronous motor and transmits the acquired data to the control board. At step 602, the control board accurately determines the motor speed and position based on the received data from the resolver. At step 602, the resolver circuit accurately determines speed and position information of the motor and transmits the information to the control board.

At step 603, based on the speed and position data, the control board generates a control signal as a form of PWM, and transmits the signal to the gate-drive board. In response to the control signal received from the control board, the gate-drive board generates a gate signal to drive the power board. The power board controls the power supplied to the permanent magnet synchronous motor.

At step 604, the control board performs closed-loop torque control by acquiring feedback torque from the motor. At step 605, the control board compares the sampled torque to a predetermined target torque.

If the sampled torque is greater than the predetermined target torque, at step 607, the control board generates a PWM signal with a decreased duty cycle. On the other hand, if the sampled torque is smaller than the predetermined target torque, at step 606, the control board generates a PWM signal with an increased duty cycle. A field oriented control (FOC) can also be used as a control algorithm in this process.

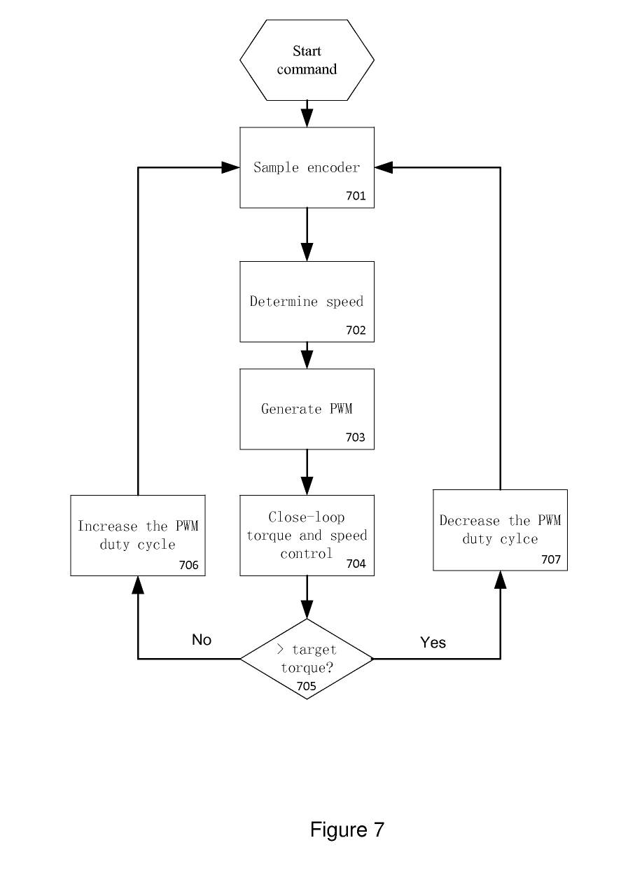

FIG. 7 represents a flow diagram illustrating DC-AC inverter control for an induction motor. Once an induction motor is connected with an encoder circuit, a control algorithm to generate the sinusoidal back EMF is used, as shown in FIG. 7.

In particular, at step 701, the encoder samples data from the induction motor and transmits the acquired data to the control board. At step 702, the control board determines the motor speed based on the data received from the encoder. At step 702, the encoder accurately determines speed information and rotating direction of the motor and transmits the information to the control board.

At step 703, based on the speed data, the control board generates a control signal as a form of PWM, and transmits the signal to the gate-drive board. In response to the control signal received from the control board, the gate-drive board generates a gate signal to drive the power board. The power board controls the power supplied to the induction motor.

As shown at step 704, the control board performs closed-loop torque and speed control by acquiring feedback torque from the motor. At step 705, the control board compares the sampled torque to a predetermined target torque.

If the sampled torque is greater than the predetermined target current, at step 707, the control board generates a PWM signal with a decreased duty cycle. On the other hand, if the sampled torque is smaller than the predetermined target torque, at step 706, the control board generates a PWM signal with an increased duty cycle. A field oriented control (FOC) can also be used as a control algorithm for the induction motor.

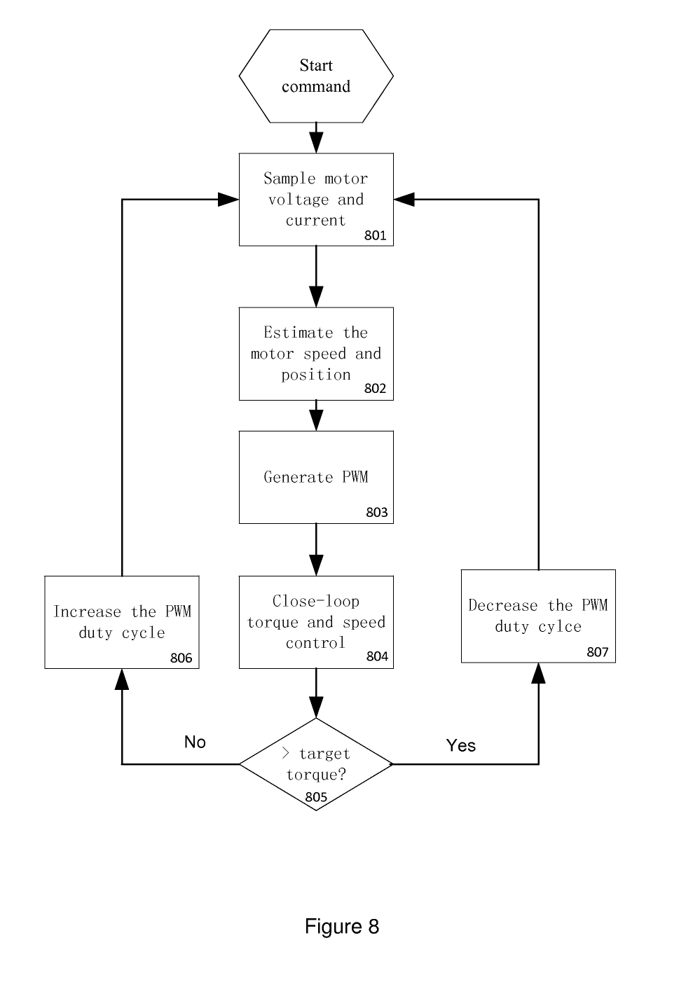

FIG. 8 represents a flow diagram illustrating DC-AC inverter control using a sensorless technique. When sensorless control is used, no speed/position information needs to be provided.

In particular, at step 801, on-board voltage and current sensors sample data from a motor and transmit the acquired data to the control board. At step 802, the control board estimates the motor speed and position based on the received data from the voltage and current sensors. The control board builds an observer to estimate the speed and position of the motor.

At step 803, based on the estimated speed and position data, the control board generates a control signal as a form of a PWM signal, and transmits the signal to the gate-drive board. In response to the control signal being received from the control board, the gate-drive board generates a gate signal to drive the power board. The power board controls the power supplied to the motor.

As shown at step 804, the control board performs closed-loop torque and speed control by acquiring feedback torque from the motor. At step 805, the control board compares the sampled torque to a predetermined target torque.

If the sampled torque is greater than the predetermined target torque, at step 807, the control board generates a PWM signal with a decreased duty cycle. On the other hand, if the sampled torque is smaller than the predetermined target torque, at step 806, the control board generates a PWM signal with an increased duty cycle. A field oriented control (FOC) can also be used as a control algorithm in this process.

The inventive concept as described above provides numerous benefits. For example, when changing the motor type, there is no need for firmware revision, which will shorten the development cycle and lower the system cost.

Also, splitting the system into three boards as in the example embodiment discussed above (i.e., the control board, the gate-drive board and the power board) can facilitate system maintenance. For example, when the switch on the power board is defective or malfunctions, only the power board needs be recalled instead of sending all three boards back. Further, splitting the system into three boards can enhance system reliability. The power board is the source of noise and heat. Isolating the control board and the gate-drive board from the power board keeps critical or sensitive components (MCU, gate-drive chips, etc) away from the heat source.

It will be understood by those familiar with this field that example embodiments may be embodied not only as an apparatus, but also as a system, method, or computer program product. Accordingly, example embodiments may take the form of an entirely hardware embodiment, an entirely software embodiment (including firmware, resident software, micro-code, etc.) or an embodiment combining software and hardware aspects that may all generally be referred to herein as an “apparatus,” “circuit,” “module” or “system.” Furthermore, example embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM, EEPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Although a wide variety of computer readable media have been described, they may generally be separated into two broad categories of non-transitory computer readable media and transitory computer readable media. The latter category includes an electrical connection, an optical fiber, and the various signal media.

Program code embodied on a computer readable medium may be transmitted using any appropriate medium, including but not limited to wireless, wireline, optical fiber cable, RF, IR, etc., or any suitable combination of the foregoing.

Computer program code for carrying out operations for example embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Example embodiments are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a hardware processor core of a computer, other programmable data processing apparatus, or other devices to function in a particular manner, such that the instructions stored in the computer readable medium form an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “one example embodiment” or “an example embodiment” means that a particular feature, structure, or characteristic described in connection with the embodiment can be included in at least one embodiment. The appearance of the phrase “in one example embodiment” in various places in the specification do not all necessarily refer to the same embodiment, nor are separate or alternative embodiments necessarily mutually exclusive of other embodiments. The same applies to the term “implementation.”

It should be understood that the steps of the example methods set forth herein are not necessarily required to be performed in the order described, and the order of the steps of such methods should be understood to be merely example Likewise, additional steps may be included in such methods, and certain steps may be omitted or combined, in methods consistent with various embodiments.

As used in this application, the word “example” is used herein to mean serving as an example, instance, or illustration. Any aspect or design described herein as “example” or “exemplary” is not necessarily to be construed as preferred or advantageous over other aspects or designs. Rather, use of the word is intended to present concepts in a concrete fashion.

The term “vehicle” or “automobile” is intended to include any moving objects such as cars, trucks, trains, scooters, bikes, etc.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

No claim element herein is to be construed under the provisions of 35 U.S.C. §112 (pre-AIA), sixth paragraph, unless the element is expressly recited using the phrase “means for” or “step for.”

It will be further understood that various changes in the details, materials, and arrangements of the parts which have been described and illustrated in order to explain the nature of described embodiments may be made by those skilled in the art without departing from the scope as expressed in the following claims.

What is claimed is:

1. An electrified vehicle comprising:
a primary battery system;
a drivetrain;
a first motor of a first respective motor type and a second motor of a second respective motor type different from the first respective motor type, the first motor and the second motor constituting at least two of a plurality of motors, the first respective motor type and the second respective motor type constituting at least two of a plurality of different motor types; and
a DC-AC inverter having different interfaces corresponding to the plurality of different motor types;
wherein the primary battery system powers at least one of the plurality of motors, via the inverter, to activate the drivetrain.

2. The electrified vehicle of claim 1, wherein the inverter comprises a plurality of distinct boards including at least a control board, a gate-drive board, and a power board.

3. The electrified vehicle of claim 1, wherein sensor information for the plurality of motors is provided by a plurality of sensors, and the sensor information provided by the plurality of sensors provides at least one of motor position information and motor speed information.

4. The electrified vehicle of claim 3, wherein DC-AC inverter is configured with at least one wire slot to accommodate the plurality of sensors.

5. The electrified vehicle of claim 4, wherein, via the wire slot, each of the plurality of sensors are independently wire-connected to the corresponding pins in the DC-AC inverter.

6. The electrified vehicle of claim 4, wherein, via the wire slot, each of the plurality of sensors are connected to a mixing zone of the DC-AC inverter, and the mixing zone comprises jumpers that implement a selection of a selected one of the plurality of sensors.

7. The electrified vehicle of claim 1, wherein the DC-AC inverter comprises an on-board voltage and current sensor, which estimates at least one of motor speed information and motor position information for an operational one of the plurality of motors.

8. The electrified vehicle of claim 1, wherein the plurality of motors are selected from a group consisting of a brushless DC motor, an induction motor, and a permanent magnet synchronous motor.

9. The electrified vehicle of claim 8, further comprising a Hall-effect sensor, an encoder, and a resolver, wherein:
the plurality of motors comprises the brushless DC motor, the induction motor, and the permanent magnet synchronous motor;
the Hall-effect sensor is configured to control the brushless DC motor;
the encoder is configured to control the induction motor; and
the resolver is configured to control the permanent magnet synchronous motor.

10. A method, for controlling a plurality of different types of motors in an electrified vehicle, comprising:
determining, by a plurality of sensors, sensor information including at least one of motor speed information and motor position information, for at least an operational one of the plurality of different types of motors;
generating, by a control board, a control signal based on the determined sensor information;
converting the control signal into a gate signal using a gate-drive board; and
controlling, by a power board, the voltage and current supplied to an electrified powertrain based on a torque request,
wherein the control board has different respective interfaces corresponding to the plurality of different types of motors.

11. The method of claim 10, wherein the sensor information is determined based on outputs of the plurality of sensors.

12. The method of claim 10, wherein the sensor information is determined based on information acquired by an on-board voltage sensor and a current sensor.

13. The method of claim 10, wherein the plurality of motors are selected from a group consisting of a brushless DC motor, an induction motor, and a permanent magnet synchronous motor.

14. The method of claim 11, wherein the plurality of sensors include a Hall-effect sensor, an encoder, and a resolver.

15. The method of claim 10, wherein the control signal generated by the control board is a six pulse-width modulation (PWM) signal.

16. The method of claim 10, wherein the control board, the gate-drive board, and the power board are three distinct functional blocks of a DC-AC inverter.

17. The method of claim 16, wherein the DC-AC inverter is configured with at least one wire slot to accommodate the plurality of sensors.

18. The method of claim 17, wherein the plurality of sensors are independently wire-connected to the corresponding pins in the DC-AC inverter via the wire slot.

19. The method of claim 17, further comprising connecting the plurality of sensors to a mixing zone in the DC-AC inverter, via the wire slot, and using jumpers to indicate a selected one of the plurality of sensors.

20. The method of claim 10, further comprising implementing a software change operation to change an operational one of the plurality of different types of motors to a different one of the plurality of different types of motors, wherein the software change operation is free of any firmware modification.

21. A method of controlling a motor, comprising:
making a determination, using a sensor, at least one of motor speed information and motor position information of the motor;
generating, by a control board, a pulse-width modulation signal based on the determination;
sampling, by the control board, at least one of phase current information and torque information of the motor, to provide sampled information;
making a comparison, by the control board, of the sampled information to at least one of a predetermined target current and a predetermined target torque; and
adjusting, by the control board, at least one of a width and a duty cycle of the pulse-width modulation signal, based on the comparison.

22. The method of claim 21, further comprising employing the motor to activate a drivetrain of an electrified vehicle.

23. The method of claim 21, wherein the motor is a brushless DC motor and the sensor is a Hall-effect sensor.

24. The method of claim 21, wherein the motor is a permanent magnet synchronous motor and the sensor is a resolver.

25. The method of claim 21, wherein the motor is an induction motor and the sensor is an encoder.

26. The method of claim 21, wherein the sensor is at least one of an on-board voltage sensor and a current sensor.

27. The method of claim 22, further comprising providing the motor as one of a plurality of motors configured to activate the drivetrain.

28. The method of claim 27, wherein the plurality of motors include a brushless DC motor, a permanent magnet synchronous motor, and an induction motor.

29. The method of claim 28, further comprising selectively switching an operational one of the plurality of motors to another of the plurality of motors, wherein the switching includes modifying software for controlling the motors but is free of any modification to firmware.

30. A non-transitory computer readable medium configured to store instructions for controlling a hardware processor to implement control operations for an electrified vehicle, the operations comprising:
making a determination of at least one of motor speed information and motor position information of a plurality of motors, the plurality of motors including a first motor of a first respective motor type and a second motor of a second respective motor type different from the first respective motor type, the first respective motor type and the second respective motor type constituting at least two of a plurality of different motor types;
generating a control signal, based on the determination, with a control board;
converting the control signal into a gate signal; and
using the gate signal and a torque request to control the voltage and current supplied to an electrified powertrain;
wherein the control board has different respective interfaces corresponding to the plurality of different motor types.

31. The non-transitory computer readable medium of claim 30, wherein the determination is based on sensor information acquired by a plurality of sensors.

32. The non-transitory computer readable medium of claim 30, wherein the determining is based on information acquired by an on-board voltage and current sensor.

33. The non-transitory computer readable medium of claim 30, wherein the plurality of motors are selected from a group consisting of a brushless DC motor, an induction motor, and a permanent magnet synchronous motor.

34. The non-transitory computer readable medium of claim 30, wherein the plurality of sensors include an Hall-effect sensor, an encoder, and a resolver.

35. The non-transitory computer readable medium of claim 30, wherein the control signal generated by the control board is a six pulse-width modulation (PWM) signal.

36. The non-transitory computer readable medium of claim 30, wherein the control board, gate-drive board and power board are three distinct functional blocks of a DC-AC inverter.

37. The non-transitory computer readable medium of claim 36, wherein DC-AC inverter is configured with at least one wire slot to accommodate the plurality of sensors.

38. The non-transitory computer readable medium of claim 37, wherein the plurality of sensors are independently wire-connected to the corresponding pins in the DC-AC inverter via the wire slot.

39. The non-transitory computer readable medium of claim 37, wherein the plurality of sensors are connected to a mixing zone via the wire slot, in the DC-AC inverter, using jumpers to select a sensor from the plurality of sensors.

40. The non-transitory computer readable medium of claim 30, wherein the operations further comprise implementing a software change operation to change an operational one of the plurality of different types of motors to a different one of the plurality of different types of motors, wherein the software change operation is free of any firmware modification.
